(19) United States
(12) Patent Application Publication
(10) Pub. No.: US 2004/0265593 A1
(43) Pub. Date: Dec. 30, 2004

(54) Method for manufacturing polarizer, optical film and image display

(75) Inventors: Takashi Kamijo, Osaka (JP); Minoru Miyatake, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 10/871,003

(22) Filed: Jun. 21, 2004

(30) Foreign Application Priority Data
Jun. 24, 2003 (JP) 2003-179437
Apr. 5, 2004 (JP) 2004-111099

(51) Int. Cl. B32B 9/04

(52) U.S. Cl. 428/411.1

(57) ABSTRACT

A method for manufacturing a polarizer comprising a film having a structure wherein a minute domain is dispersed in a matrix formed of a translucent water-soluble resin including an iodine light absorbing material, the method comprising the steps of: forming a film from a solution including the translucent water-soluble resin, iodine and a material forming the minute domain; and stretching the film. The obtained iodine based polarizer has a high polarization degree.

### BACKGROUND OF THE INVENTION

1. Field of the Invention

The present invention relates to a method for manufacturing the polarizer. Also the present invention relates to a polarizer obtained by the manufacturing method, and a lo polarizing plate and an optical film using the polarizer concerned. Furthermore, this invention relates to an image display, such as a liquid crystal display, an organic electroluminescence display, a CRT and a PDP using the polarizing plate and the optical film concerned.

2. Description of the Prior Art

Liquid crystal display are rapidly developing in market, such as in clocks and watches, cellular phones, PDAs, notebook-sized personal computers, and monitor for personal computers, DVD players, TVs, etc. In the liquid crystal display, visualization is realized based on a variation of polarization state by switching of a liquid crystal, where polarizers are used based on a display principle thereof. Particularly, usage for TV etc. increasingly requires display with high luminance and high contrast, polarizers having higher brightness (high transmittance) and higher contrast (high polarization degree) are being developed and introduced.

As polarizers, for example, since it has a high transmittance and a high polarization degree, polyvinyl alcohols having a structure in which iodine is absorbed and then stretched, that is, iodine based polarizers are widely used (for example, Japanese Patent Laid-Open No.2001-296427). In a method for manufacturing iodine based polarizers, a method is commonly used wherein a poly vinylalcohol based film is immersed in a bath comprising an aqueous solution including iodine, and dyed, as a method of making iodine absorbed to polyvinyl alcohols. However, since iodine may not fully be dyed to the film, this method may be unable to provide polarizer having desired optical characteristics, when the polyvinyl alcohol based film has high crystallinity.

In order to cope with such problem, a method is proposed that a poly vinylalcohol based film is manufactured from an aqueous solution including a polyvinyl alcohol based resin and iodine mixed beforehand, and the obtained film is then stretched (refer to Japanese Patent Laid-Open Publication No. 08-190017). According to the method of the reference, iodine is fully dyed to the film and a polarizer having target optical characteristics may be obtained. However, further improvement in polarization characteristics is desired also about the polarizer obtained by the method.

### SUMMARY OF THE INVENTION

These invention aims at providing a method for manufacturing iodine based polarizer having a high polarization degree.

Moreover, these invention aims at providing a polarizer obtained by the manufacturing method, a polarizing plate and an optical film using the polarizer concerned. Furthermore, this invention aims at providing an image display using the polarizer, the polarizing plate, and the optical film concerned.

As a result of examination wholeheartedly performed by the present inventors that the above-mentioned subject should be solved, it was found out that the above-mentioned purpose might be attained following a method for manufacturing an polarizer shown below, leading to completion of this invention.

That is, this invention relates to a method for manufacturing a polarizer comprising a film having a structure wherein a minute domain is dispersed in a matrix formed of a translucent water-soluble resin including an iodine light absorbing material, the method comprising the steps of:

forming a film from a solution including the translucent water-soluble resin, iodine and a material forming the minute domain; and

stretching the film.

Also this invention relates to a method for manufacturing a polarizer comprising a film having a structure wherein a minute domain is dispersed in a matrix formed of a translucent water-soluble resin including an iodine light absorbing material, the method comprising the steps of:

forming a film from a solution including the translucent water-soluble resin, an alkali metal iodide and a material forming the minute domain;

oxidizing the iodide to form iodine; and

stretching the film.

In the method for manufacturing the polarizer, minute domains are preferably formed of aligned birefringent materials. The birefringent materials preferably show liquid crystallinity at least at a step of alignment processing.

In the method for manufacturing the polarizer in the present invention, since a translucent water-soluble resin is mixed with iodine or alkali metal iodides forming an iodine light absorbing material before forming a film, the resulting film is sufficiently dyed with an iodine light absorbing material, thus showing a high light polarizing performance. Iodine light absorbing material means chemical species comprising iodine and absorbs visible light, and it is thought that, in general, they are formed by interaction between translucent water-soluble resins (particularly polyvinyl alcohol based resins) and poly iodine ions (I₃_{⁻}, I₅_{⁻}, etc.). An iodine light absorbing material is also called an iodine complex. It is thought that poly iodine ions are generated from iodine and iodide ions.

In the method for manufacturing the polarizer in the present invention, the polarizer has an iodine based polarizer formed by a translucent water-soluble resin and an iodine light absorbing material as a matrix, and has dispersed minute domains in the above-mentioned matrix. Aligned materials having birefringence preferably form minute domains, and particularly minute domains are formed preferably with materials showing liquid crystallinity. Thus, in addition to function of absorption dichroism by iodine light absorbing materials, characteristics of having function of scattering anisotropy improve polarization performance according to synergistic effect of the two functions, and as a result a polarizer having both of transmittance and polarization degree, and excellent visibility may be provided.

Scattering performance of anisotropic scattering originates in refractive index difference between matrixes and minute domains. For example, if materials forming minute domains are liquid crystalline materials, since they have higher wavelength dispersion of Δn compared with translucent water-soluble resins as a matrix, a refractive index difference in scattering axis becomes larger in shorter wavelength side, and, as a result, it provides more amounts of scattering in shorter wavelength. Accordingly, an improving effect of large polarization performance is realized in shorter wavelengths, compensating a relative low level of polarization performance of an iodine based polarizer in a side of shorter wavelength, and thus a polarizer having high polarization and neutral hue may be realized.

In the above-mentioned method for manufacturing the polarizer, it is preferable that the minute domains have a birefringence of 0.02 or more. In materials used for minute domains, in the view point of gaining larger anisotropic scattering function, materials having the above-mentioned birefringence may be preferably used.

In the above-mentioned method for manufacturing the polarizer, in a refractive index difference between the birefringent material forming the minute domains and the translucent water-soluble resin in each optical axis direction, a refractive index difference (Δn¹) in direction of axis showing a maximum is 0.03 or more, and a refractive index difference (Δn²) between the Δn¹ direction and a direction of axes of two directions perpendicular to the Δn¹ direction is 50% or less of the Δn¹

Control of the above-mentioned refractive index difference (Δn¹) and (Δn²) in each optical axis direction into the above-mentioned range may provide a scattering anisotropic film having function being able to selectively scatter only linearly polarized light in the Δn¹ direction, as is submitted in U.S. Pat. No. 2,123,902 specification. That is, on one hand, having a large refractive index difference in the Δn¹ direction, it may scatter linearly polarized light, and on the other hand, having a small refractive index difference in the Δn² direction, it may transmit linearly polarized light. Moreover, refractive index differences (Δn²) in the directions of axes of two directions perpendicular to the Δn¹ direction are preferably equal.

In order to obtain high scattering anisotropy, a refractive index difference (Δn¹) in a Δn¹ direction is set 0.03 or more, preferably 0.05 or more, and still preferably 0.10 or more. A refractive index difference (Δn²) in two directions perpendicular to the Δn¹ direction is 50% or less of the above-mentioned Δn¹, and preferably 30% or less.

In iodine light absorbing material in the above-mentioned method for manufacturing the polarizer, an absorption axis of the material concerned preferably is orientated in the Δn¹ direction.

The iodine light absorbing material in a matrix is orientated so that an absorption axis of the material may become parallel to the above-mentioned Δn¹ direction, and thereby linearly polarized light in the Δn¹ direction as a scattering polarizing direction may be selectively absorbed. As a result, on one hand, a linearly polarized light component of incident light in a Δn² direction is not scattered or hardly absorbed by the iodine light absorbing material as in conventional iodine based polarizers without anisotropic scattering performance. On the other hand, a linearly polarized light component in the Δn¹ direction is scattered, and is absorbed by the iodine light absorbing material. Usually, absorption is determined by an absorption coefficient and a thickness. In such a case, scattering of light greatly lengthens an optical path length compared with a case where scattering is not given. As a result, polarized component in the Δn¹ direction is more absorbed as compared with a case in conventional iodine based polarizers. That is, higher polarization degrees may be attained with same transmittances.

Descriptions for ideal models will, hereinafter, be given. Two main transmittances usually used for linear polarizer (a first main transmittance k₁ (a maximum transmission direction=linearly polarized light transmittance in a Δn² direction), a second main transmittance k₂ (a minimum transmission direction=linearly polarized light transmittance in a Δn¹ direction)) are, hereinafter, used to give discussion.

In commercially available iodine based polarizers, when iodine light absorbing materials are aligned in one direction, a parallel transmittance and a polarization degree may be represented as follows, respectively:

parallel transmittance=0.5×((k₁)²+(k₂)²) and

polarization degree=(k₁−k₂)/(k₁+k₂).

On the other hand, when it is assumed that, in a polarizer of this invention, a polarized light in a Δn¹ direction is scattered and an average optical path length is increased by a factor of Δ (>1), and depolarization by scattering may be ignored, main transmittances in this case may be represented as k₁ and k₂′=10^{X} (where, x is αlog k₂), respectively That is, a parallel transmittance in this case and the polarization degree are represented as follows:

parallel transmittance=0.5×((k₁)²+(k₂′)2) and

polarization degree=(k₁−k₂′)/(k₁+k₂′).

When a polarizer of this invention is prepared by a same condition (an amount of dyeing and production procedure are same) as in commercially available iodine based polarizers (parallel transmittance 0.385, polarization degree 0.965: k₁=0.877, k₂=0.016), on calculation, when α is 2 times, k₂ becomes small reaching 0.0003, and as result, a polarization degree improves up to 0.999, while a parallel transmittance is maintained as 0.385. The above-mentioned result is on calculation, and function may decrease a little by effect of depolarization caused by scattering, surface reflection, backscattering, etc. As the above-mentioned equations show, higher value α may give better results and higher dichroic ratio of the iodine light absorbing material may provide higher function. In order to obtain higher value α, a highest possible scattering anisotropy function may be realized and polarized light in a Δn¹ direction may just be selectively and strongly scattered. Besides, less backscattering is preferable, and a ratio of backscattering strength to incident light strength is preferably 30% or less, and more preferably 20% or less.

In the above-mentioned method for manufacturing the polarizer, minute domains preferably have a length in a Δn² direction of 0.05 through 500 μm.

In order to scatter strongly linearly polarized light having a plane of vibration in a Δn¹ direction in wavelengths of visible light band, dispersed minute domains have a length controlled to 0.05 through 500 μm in a Δn² direction, and preferably controlled to 0.5 through 100 μm. When the length in the Δn² direction of the minute domains is too short a compared with wavelengths, scattering may not fully provided. On the other hand, when the length in the Δn² direction of the minute domains is too long, there is a possibility that a problem of decrease in film strength or of liquid crystalline material forming minute domains not fully aligned in the minute domains may arise.

In the above-mentioned method for manufacturing the polarizer, iodine light absorbing materials having an absorption band at least in a wavelength range of 400 through 700 nm may be used.

Also this invention relates to a polarizer obtained by the above-mentioned manufacturing method.

Besides, this invention relates to a polarizing plate which having a transparent protection layer at least on one side of the above-mentioned polarizer.

Moreover, this invention relates to an optical film characterized by being laminated with at least one of the above-mentioned polarizer and the above-mentioned polarizing plate.

Furthermore, this invention relates to an image display characterized by using the above-mentioned polarizer, the above-mentioned polarizing plate, or the above-mentioned optical film.

### BRIEF DESCRIPTION OF THE DRAWING

FIG. 1 is a conceptual diagram showing an example of polarizer of the present invention.

### DESCRIPTION OF THE PREFERRED EMBODIMENTS

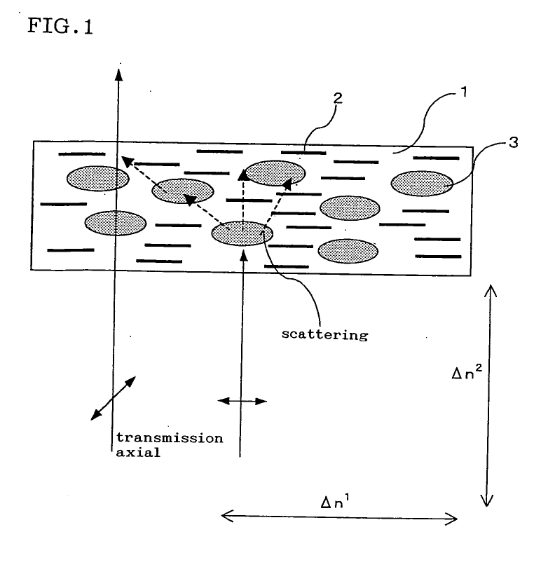

A polarizer obtained in this invention will, hereinafter, be described referring to drawings. FIG. 1 is a conceptual top view of a polarizer of this invention, and the polarizer has a structure where a film is formed with a translucent water-soluble resin 1 including an iodine light absorbing material 2, and minute domains 3 are dispersed in the film concerned as a matrix.

FIG. 1 shows an example of a case where the iodine light absorbing material 2 is aligned in a direction of axis (Δn¹ direction) in which a refractive index difference between the minute domain 3 and the translucent water-soluble resin 1 shows a maximal value. In minute domain 3, a polarized component in the Δn¹ direction is scattered. In FIG. 1, the Δn¹ direction in one direction in a film plane is an absorption axis. In the film plane, a Δn² direction perpendicular to the Δn¹ direction serves as a transmission axis. Another Δn² direction perpendicular to the Δn¹ direction is a thickness direction.

As translucent water-soluble resins 1, resins having translucency in a visible light band and dispersing and absorbing the iodine light absorbing materials may be used without particular limitation. For example, polyvinyl alcohols or derivatives thereof conventionally used for polarizers may be mentioned. As derivatives of polyvinyl alcohol, polyvinyl formals, polyvinyl acetals, etc. may be mentioned, and in addition derivatives modified with olefins, such as ethylene and propylene, and unsaturated carboxylic acids, such as acrylic acid, methacrylic acid, and crotonic acid, alkyl esters of unsaturated carboxylic acids, acrylamides etc. may be mentioned. Besides, as translucent water-soluble resin 1, for example, polyvinyl pyrrolidone based resins, amylose based resins, etc. may be mentioned. The above-mentioned translucent water-soluble resin may be of resins having isotropy not easily generating alignment birefringence caused by molding deformation etc., and of resins having anisotropy easily generating alignment birefringence.

The iodine light absorbing material 2 is produced from iodine, or iodides of alkali metals. As alkali metal iodides, potassium iodide, sodium iodide, lithium iodide, etc. may be mentioned. The iodides are oxidized to produce the iodine light absorbing material 2.

In materials forming minute domains 3, it is not limited whether the material has birefringence or isotropy, but materials having birefringence is particularly preferable. Moreover, as materials having birefringence, materials (henceforth, referred to as liquid crystalline material) showing liquid crystallinity at least at the time of alignment treatment may preferably be used. That is, the liquid crystalline material may show or may lose liquid crystallinity in the formed minute domain 3, as long as it shows liquid crystallinity at the alignment treatment time.

As materials forming minute domains 3, materials having birefringences (liquid crystalline materials) may be any of materials showing nematic liquid crystallinity, smectic liquid crystallinity, and cholesteric liquid crystallinity, or of materials showing lyotropic liquid crystallinity. Moreover, materials having birefringence may be of liquid crystalline thermoplastic resins, and may be formed by polymerization of liquid crystalline monomers. When the liquid crystalline material is of liquid crystalline thermoplastic resins, in the view point of heat-resistance of structures finally obtained, resins with high glass transition temperatures may be preferable. Furthermore, it is preferable to use materials showing glass state at least at room temperatures. Usually, a liquid crystalline thermoplastic resin is aligned by heating, subsequently cooled to be fixed, and forms minute domains 3 while liquid crystallinity are maintained. Although liquid crystalline monomers after orienting can form minute domains 3 in the state of fixed by polymerization, cross-linking, etc., some of the formed minute domains 3 may lose liquid crystallinity.

As the above-mentioned liquid crystalline thermoplastic resins, polymers having various skeletons of principal chain types, side chain types, or compounded types thereof may be used without particular limitation. As principal chain type liquid crystal polymers, polymers, such as condensed polymers having structures where mesogen groups including aromatic units etc. are combined, for example, polyester based, polyamide based, polycarbonate based, and polyester imide based polymers, may be mentioned. As the above-mentioned aromatic units used as mesogen groups, phenyl based, biphenyl based, and naphthalene based units may be mentioned, and the aromatic units may have substituents, such as cyano groups, alkyl groups, alkoxy groups, and halogen groups.

As side chain type liquid crystal polymers, polymers having principal chain of, such as polyacrylate based, polymethacrylate based, poly-alpha-halo acrylate based, poly-alpha-halo cyano acrylate based, polyacrylamide based, polysiloxane based, and poly malonate based principal chain as a skeleton, and having mesogen groups including cyclic units etc. in side chains may be mentioned. As the above-mentioned cyclic units used as mesogen groups, biphenyl based, phenyl benzoate based, phenylcyclohexane based, azoxybenzene based, azomethine based, azobenzene based, phenyl pyrimidine based, diphenyl acetylene based, diphenyl benzoate based, bicyclo hexane based, cyclohexylbenzene based, terphenyl based units, etc. may be mentioned. Terminal groups of these cyclic units may have substituents, such as cyano group, alkyl group, alkenyl group, alkoxy group, halogen group, haloalkyl group, haloalkoxy group, and haloalkenyl group. Groups having halogen groups may be used for phenyl groups of mesogen groups.

Besides, any mesogen groups of the liquid crystal polymer may be bonded via a spacer part giving flexibility. As spacer parts, polymethylene chain, polyoxymethylene chain, etc. may be mentioned. A number of repetitions of structural units forming the spacer parts is suitably determined by chemical structure of mesogen parts, and the number of repeating units of polymethylene chain is 0 through 20, preferably 2 through 12, and the number of repeating units of polyoxymethylene chain is 0 through 10, and preferably 1 through 3.

The above-mentioned liquid crystalline thermoplastic resins preferably have glass transition temperatures of 50° C. or more, and more preferably 80° C. or more. Furthermore they have approximately 2,000 through 100,000 of weight average molecular weight.

As liquid crystalline monomers, monomers having polymerizable functional groups, such as acryloyl groups and methacryloyl groups, at terminal groups, and further having mesogen groups and spacer parts including the above-mentioned cyclic units etc. may be mentioned. Crossed-linked structures may be introduced using polymerizable functional groups having two or more acryloyl groups, methacryloyl groups, etc., and durability may also be improved.

Materials forming minute domains 3 are not entirely limited to the above-mentioned liquid crystalline materials, and non-liquid crystalline resins may be used if they are different materials from the matrix materials. As the above-mentioned resins, polyvinyl alcohols and derivatives thereof, polyolefins, polyallylates, polymethacrylates, polyacrylamides, polyethylene terephthalates, acrylic styrene copolymes, etc. may be mentioned. Moreover, particles without birefringence may be used as materials for forming the minute domains 3. As fine-particles concerned, resins, such as polyacrylates and acrylic styrene copolymers, may be mentioned. A size of the fine-particles is not especially limited, and particle diameters of 0.05 through 500 μm may be used, and preferably 0.5 through 100 μm. Although it is preferable that materials for forming minute domains 3 is of the above-mentioned liquid crystalline materials, non-liquid crystalline materials may be mixed and used to the above-mentioned liquid crystalline materials. Furthermore, as materials for forming minute domains 3, non-liquid crystalline materials may also be independently used.

In a method for manufacturing the polarizer of the present invention, while a film in which a matrix is formed of a translucent water-soluble resin 1 including an iodine light absorbing material 2 is produced, minute domains 3 (for example, aligned birefringent material formed of a liquid crystalline material) are dispersed in the matrix concerned. In the film, the refractive index difference (Δn¹) in a Δn¹ direction and the refractive index difference (Δn²) in a Δn² direction are controlled so as to be in the above-mentioned range.

Although a manufacturing process of the polarizer of the present invention is not especially limited, for example, following processes may be used:

(1) a process for producing a mixed solution in which a material forming minute domains is dispersed in a translucent water-soluble resin to form a matrix, (a case, where a liquid crystalline material is used as a material forming minute domains, will be described as a typical example, and this case of a liquid crystalline material will be applied also in other materials) and iodine;

(2) a process in which a mixed solution obtained in the above-mentioned (1) is formed into a film;

(3) a process in which the film obtained in the above-mentioned (2) is stretched.

A mixed solution is prepared in the process (1). As methods of preparation of the mixed solution, either of following methods may be adopted: a method in which after a liquid crystalline material is dispersed in an aqueous solution of translucent water-soluble resin for forming a matrix, iodine is mixed; and a method in which after iodine is mixed in an aqueous solution of translucent water-soluble resin, a liquid crystalline material is dispersed. However, the latter method has following tendency: mixing of iodine to an aqueous solution of the translucent water-soluble resin makes the solution to be gelled, depending on an amount of iodine or on a structure and a molecular weight of the translucent water-soluble resin, etc. This is understood that an iodine light absorbing material is produced, and then this works as a cross-linking point of the translucent water-soluble resin (especially polyvinyl alcohol based resins). Gelation makes difficult dispersion of liquid crystalline materials into the mixed solution. Heating of the gelled solution changes it into flowing state, and makes dispersion of liquid crystalline material easier, and thereby a method may be adopted that after the solution concerned is warmed and changed into flowing state, the liquid crystalline materials are mixed. Thus, since the latter method complicates a process, in order to simplify the process, the former method is preferred in which the liquid crystalline material is first dispersed into the aqueous solution of translucent water-soluble resin. Hereinafter, description will be given for the former method.

Methods of dispersing a liquid crystalline material forming minute domains in a translucent water-soluble resin forming matrix are not especially limited, but a method of using phase separation phenomenon between the matrix component (translucent water-soluble resin) and the liquid crystalline material may be mentioned. For example, a method may be mentioned in which a material having a low compatibility with the matrix component is selected as a liquid crystalline material, and then a solution of the material forming the liquid crystalline material is dispersed in the aqueous solution of matrix component via dispersing agents, such as surface-active agents. Dispersing agents may not be used depending on a combination of a translucency material forming the matrix, and a liquid crystal material forming the minute domains. An amount to be used of the liquid crystalline material dispersed in the matrix is not especially limited, but the liquid crystalline material is in an amount of 0.01 to 100 parts by weight to the translucent water-soluble resin 100 parts by weight, and preferably 0.1 to 10 parts by weight. The liquid crystalline material may be used in dissolved state or not dissolved state in solvents. As solvents, for example, there may be mentioned: water, toluene, xylene, hexane, cyclohexane, dichloromethane, trichloromethane, dichloroethane, trichloroethane, tetrachloroethane, trichloroethylene, methyl ethyl ketone, methylisobutylketone, cyclohexanone, cyclopentanone, tetrahydrofuran, ethyl acetate, etc. Solvents of the matrix component and solvents of the liquid crystalline material may be equivalent with each other, and may be different from each other.

In order to reduce foaming in a drying stage after film formation in the process (2), a solvent for dissolving the liquid crystalline material forming the minute domains is not preferably used in preparation of a mixed solution in the process (1). When solvents are not used, for example, a method may be mentioned in which the liquid crystalline material is directly added in the aqueous solution of the material with translucency for forming the matrix, and then the obtained aqueous solution is heated at temperatures not less than liquid crystal temperature range in order to disperse the liquid crystalline material uniformly and smaller to promote dispersing.

As mixing methods of iodine to the solution, a method of mixing iodine aqueous solution is usually used. In order to help dissolution of iodine, alkali metal iodides, such as potassium iodide, etc. are usually included in the iodine aqueous solution. Although an amount of iodine is not especially limited since it is suitably determined according to target optical characteristics, it is 0.1 to 10 parts by weight to the matrix component (translucent water-soluble resin) 100 parts by weight, and preferably 0.5 to 5 parts by weight. Moreover, an amount of iodides is 100 to 3000 parts by weight to Iodine 100 parts by weight, and preferably 200 to 1000 parts by weight.

A temperature in preparing the mixed solution is not especially limited. When the temperature is low, that is, especially at 40° C. or less, the mixed solution becomes easily to be gelled. On the other hand, in the case of 40° C. or more, the mixed solution will easily be in a sol state. In consideration of this tendency, temperatures of the mixed solution are used that may realize an optimal viscosity state for the film-forming method adopted in process (2). For example, when the process (2) adopts a film-forming method by a solution casting method, a temperature of the mixed solution is preferably acceptable for sol state (40° C. or more).

In addition, a solution of a matrix component, a solution of a liquid crystalline material, or a mixed solution may include various kinds of additives, such as dispersing agents, surface active agents, ultraviolet absorption agents, flame retardants, antioxidants, plasticizers, mold lubricants, other lubricants, and colorants in a range not disturbing an object of this invention.

In the process (2) for obtaining a film of the above-mentioned mixed solution, the above-mentioned mixed solution is heated and dried to remove solvents, and thus a film with minute domains dispersed in the matrix is produced. As methods for formation of the film, various kinds of methods, such as casting methods, extrusion methods, injection molding methods, roll molding methods, and flow casting molding methods, may be adopted. In film molding, a size of minute domains in the film is controlled to be in a range of 0.05 through 500 μm in a Δn² direction. Sizes and dispersibility of the minute domains may be controlled, by adjusting a viscosity of the mixed solution, selection and combination of the solvent of the mixed solution, dispersant, and thermal processes (cooling rate) of the mixed solvent and a rate of drying. For example, a mixed solution of a translucent water-soluble resin that has a high viscosity and generates high shearing force and that forms a matrix, and a liquid crystalline material forming minute domains is dispersed by agitators, such as a homogeneous mixer, being heated at a temperature in no less than a range of a liquid crystal temperature, and thereby minute domains may be dispersed in a smaller state.

The process (3) for stretching the film aims at orienting a liquid crystalline material that forms minute domains in addition to orienting an iodine light absorbing material in a stretching direction. As stretching method, a uniaxial stretching method, a biaxial stretching method, a tilt stretching method, etc. may be mentioned, and the uniaxial stretching is usually adopted. As the stretching method, either of a dry type stretching in air, and a wet type stretching in an aqueous bath may be adopted. Although a stretching ratio is not especially limited, approximately 2 to 10 times is usually preferable.

This stretching may orient the iodine light absorbing material in a direction of stretching axis. Moreover, the liquid crystalline material forming a birefringent material is aligned in the stretching direction in minute domains by the above-mentioned stretching, and as a result birefringence is demonstrated.

It is desirable the minute domains may be deformed according to stretching. When minute domains are of non-liquid crystalline materials, approximate temperatures of glass transition temperatures of the resins are desirably selected as stretching temperatures, and when the minute domains are of liquid crystalline materials, temperatures making the liquid crystalline materials exist in a liquid crystal state such as nematic phase or smectic phase or an isotropic phase state, are desirably selected as stretching temperatures. When inadequate alignment is given by stretching process, processes, such as heating alignment treatment, may separately be added.

In addition to the above-mentioned stretching, function of external fields, such as electric field and magnetic field, may be used for alignment of the liquid crystalline material. Moreover, liquid crystalline materials mixed with light reactive substances, such as azobenzene, and liquid crystalline materials having light reactive groups, such as a cinnamoyl group, introduced thereto are used, and thereby these materials may be aligned by alignment processing with light irradiation etc. Furthermore, a stretching processing and the above-mentioned alignment processing may also be used in combination. When the liquid crystalline material is of liquid crystalline thermoplastic resins, it is aligned at the time of stretching, cooled at room temperatures, and thereby alignment is fixed and stabilized. Since target optical property will be demonstrated if alignment is carried out, the liquid crystalline monomer may not necessarily be in a cured state. However, in liquid crystalline monomers having low isotropic transition temperatures, a few temperature rise provides an isotropic state. In such a case, since anisotropic scattering may not be demonstrated but conversely polarized light performance deteriorates, the liquid crystalline monomers are preferably cured. Besides, many of liquid crystalline monomers will be crystallized when left at room temperatures, and then they will demonstrate anisotropic scattering and polarized light performance conversely deteriorate, the liquid crystalline monomers are preferably cured. In the view point of these phenomena, in order to make alignment state stably exist under any kind of conditions, liquid crystalline monomers are preferably cured. In curing, for example, the liquid crystalline monomer is mixed with a photopolymerization initiator to be dispersed in a solution of a matrix component, and subsequently, after alignment, it is cured by irradiation with ultraviolet radiation etc. and thereby alignment can be stabilized. This light irradiation need not to be performed immediately after alignment, and may be performed in any process of the manufacturing processes.

The stretching process (3) may be performed two or more times. In the process, temperatures, methods (wet stretching method, dry stretching method), kinds and amounts, etc. of compounds to be mixed, which are contained in the bath for immersion (in a case of wet stretching), are not especially limited, and also combination thereof is not especially limited. As a compound to be mixed, various kinds thereof, cross linking agents such as boric acid, and hue modifiers such as alkali metal iodides may be mentioned.

As the stretching method, for example, a method may be mentioned in which a first stretching is performed to orient an iodine light absorbing material and a liquid crystalline material using dry type stretching, and then after alignment of the liquid crystal is fixed, additional wet stretching is performed to further orient the iodine light absorber itself. Moreover, for example, a method may be mentioned in which after only the iodine light absorbing material is stretched and aligned, a stretching in a comparatively hot bath orients an iodine light absorbing material and liquid crystal. Naturally, stretching methods are not limited to them.

In production of polarizer, processes for various purposes other than processes (1) to (3) may be adopted. For example, a process of heat-treating a formed film for the purpose of increasing crystallinity thereof may be mentioned. The heat treatment process is usually performed before stretching process (3) of the film, and it may also be performed after the stretching process (3). A heat treatment temperature is about 50 to 150° C., and preferably 60 to 120° C. Excessively high temperatures sublimate iodine and may not develop required optical characteristics.

Moreover, for example, a process may be mentioned in which a film is immersed in a water bath in order to swell the film. Moreover, processes to immerse a film in a water bath including arbitrary additives dissolved therein may be mentioned. Processes may also be mentioned in which a film is immersed in an aqueous solution including additives, such as boric acid and borax, for a purpose of cross-linking over water-soluble resins (matrix). Moreover, there may be mentioned processes of immersing a film in an aqueous solution including additives, such as alkali metal iodides, for a purpose of adjusting a balance of an amount of iodine light absorbing materials dispersed therein, and of adjusting hue. These processes may be added in any order or combination before or after the stretching process (3), and they may be performed simultaneously with the stretching process (3) in each bath of the processes.

A method for manufacturing a polarizer has been described above in which a mixed solution prepared by mixing iodine together with a material forming minute domains is used for an aqueous solution of a translucent water-soluble resin in the process (1). In the present invention, a process (1′) using a mixed solution obtained by mixing alkali metal iodides is employable instead of a process of mixing iodine in an aqueous solution of a translucent water-soluble resin in the process (1). Also using the mixed solution concerned, iodine can be included in a matrix component (translucent water-soluble resin). A same film forming process (2) and a same stretching process (3) as in the above-mentioned methods are given to a mixed solution including the iodide, and an additional process (4) for producing iodine by oxidation of iodides is separately given in addition to these processes.

As oxidation methods for the process (4), there may be mentioned: a method to immerse a film in an oxidation baths, such as a hydrogen peroxide aqueous solution, a potassium permanganate aqueous solution, (refer to Japanese Patent Laid-Open Publication No. 07-104126); and a method to immerse a film in an aqueous solution of water-soluble polyvalent metal salts, such as cupric sulfate and iron citrates, (refer to Japanese Patent Laid-Open Publication No. 02-73309), and others. In these methods, a production amount of iodine (I₂), which is a grade of oxidation, is controlled by concentrations of aqueous solution, temperatures of bath, immersion time, etc. Moreover, as methods of oxidation, in addition to the above-mentioned methods, a method to irradiate ultraviolet radiation to a film, and furthermore, a method in which visible light is irradiated after making a film include photo-oxidation catalysts as titanium oxide etc. may be mentioned. The oxidation process (4) concerned may be performed at either timing of: in the process (2); before the process (3) and after the process (2); in the process (3). There is a possibility that the solution may form a gel and film formation may become difficult when the oxidation process (4) is performed in a state of solution, and an iodine light absorbing material may not be fully aligned when oxidation is performed after stretching. Therefore, especially the oxidation process (4) is preferably carried out in a stage before the process (3) and after the process (2) from a viewpoint of realizing stabilized and excellent polarization characteristics.

A film given the above treatments is desirably dried using suitable conditions. Drying is performed according to conventional methods.

A thickness of the obtained polarizer (film) is not especially limited, in general, but it is 1 μm through 3 mm, preferably 5 μm through 1 mm, and more preferably 10 through 500 μm.

A polarizer obtained in this way does not especially have a relationship in size between a refractive index of the birefringent material forming minute domains and a refractive index of the matrix resin in a stretching direction, whose stretching direction is in a Δn¹ direction and two directions perpendicular to a stretching axis are Δn² directions. Moreover, the stretching direction of an iodine light absorbing material is in a direction demonstrating maximal absorption, and thus a polarizer having a maximally demonstrated effect of absorption and scattering may be realized.

Since a polarizer obtained by this invention has equivalent functions as in existing absorbed type polarizing plates, it may be used in various applicable fields where absorbed type polarizing plates are used without any change.

The above-described polarizer may be used as a polarizing plate with a transparent protective layer prepared at least on one side thereof using a usual method. The transparent protective layer may be prepared as an application layer by polymers, or a laminated layer of films. Proper transparent materials may be used as a transparent polymer or a film material that forms the transparent protective layer, and the material having outstanding transparency, mechanical strength, heat stability and outstanding moisture interception property, etc. may be preferably used. As materials of the above-mentioned protective layer, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; allylate type polymers; polyoxymethylene type polymers; epoxy type polymers; or blend polymers of the above-mentioned polymers may be mentioned. Films made of heat curing type or ultraviolet ray curing type resins, such as acryl based, urethane based, acryl urethane based, epoxy based, and silicone based, etc. may be mentioned.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

As a transparent protection film, if polarization property and durability are taken into consideration, cellulose based polymer, such as triacetyl cellulose, is preferable, and especially triacetyl cellulose film is suitable. In general, a thickness of a transparent protection film is 500 μm or less, preferably 1 through 300 μm, and especially preferably 5 through 300 μm. In addition, when transparent protection films are provided on both sides of the polarizer, transparent protection films comprising same polymer material may be used on both of a front side and a back side, and transparent protection films comprising different polymer materials etc. may be used.

Moreover, it is preferable that the transparent protection film may have as little coloring as possible. Accordingly, a protection film having a retardation value in a film thickness direction represented by Rth=[(nx+ny)/2−nz]×d of −90 nm through +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protection film may mostly be cancelled using a protection film having a retardation value (Rth) of −90 nm through +75 nm in a thickness direction. The retardation value (Rth) in a thickness direction is preferably −80 nm through +60 nm, and especially preferably −70 nm through +45 nm.

A hard coat layer may be prepared, or antireflection processing, processing aiming at sticking prevention, diffusion or anti glare may be performed onto the face on which the polarizing film of the above described transparent protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight part to the transparent resin 100 weight part that forms the fine concavo-convex structure on the surface, and preferably 5 to 25 weight part. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective layer.

Adhesives are used for adhesion processing of the above described polarizing film and the transparent protective film. As adhesives, isocyanate derived adhesives, polyvinyl alcohol derived adhesives, gelatin derived adhesives, vinyl polymers derived latex type, aqueous polyesters derived adhesives, etc. may be mentioned. The above-described adhesives are usually used as adhesives comprising aqueous solution, and usually contain solid of 0.5 to 60% by weight.

A polarizing plate of the present invention is manufactured by adhering the above-described transparent protective film and the polarizing film using the above-described adhesives. The application of adhesives may be performed to any of the transparent protective film or the polarizing film, and may be performed to both of them. After adhered, drying process is given and the adhesion layer comprising applied dry layer is formed. Adhering process of the polarizing film and the transparent protective film may be performed using a roll laminator etc. Although a thickness of the adhesion layer is not especially limited, it is usually approximately 0.1 to 5 μm.

A polarizing plate of the present invention may be used in practical use as an optical film laminated with other optical layers. Although there is especially no limitation about the optical layers, one layer or two layers or more of optical layers, which may be used for formation of a liquid crystal display etc., such as a reflector, a transfiective plate, a retardation plate (a half wavelength plate and a quarter wavelength plate included), and a viewing angle compensation film, may be used. Especially preferable polarizing plates are; a reflection type polarizing plate or a transfiective type polarizing plate in which a reflector or a transflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

As an example of a reflection type polarizing plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarizing plate, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transfilective type polarizing plate may be obtained by preparing the above-mentioned reflective layer as a transflective type reflective layer, such as a half-mirror etc. that reflects and transmits light. A transflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transfilective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

The above-mentioned polarizing plate may be used as elliptically polarizing plate or circularly polarizing plate on which the retardation plate is laminated. A description of the above-mentioned elliptically polarizing plate or circularly polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates, birefringence films formed by stretching films comprising suitable polymers, such as polycarbonates, norbornene type resins, polyvinyl alcohols, polystyrenes, poly methyl methacrylates, polypropylene; polyallylates and polyamides; aligned films comprising liquid crystal materials, such as liquid crystal polymer; and films on which an alignment layer of a liquid crystal material is supported may be mentioned. A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarizing plate and an above-mentioned reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or orthogonal biaxial stretching and a biaxial stretched film as inclined alignment film etc. may be used. As inclined alignment film, for example, a film obtained using a method in which a heat shrinking film is adhered to a polymer film, and then the combined film is heated and stretched or shrinked under a condition of being influenced by a shrinking force, or a film that is aligned in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy (D-BEF and others manufactured by 3M Co., Ltd.); an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported(PCF350 manufactured by NITTO DENKO CORPORATION, Transmax manufactured by Merck Co., Ltd., and others); etc. may be mentioned.

Therefore, in the brightness enhancement film of a type that transmits a linearly polarized light having the above-mentioned predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light band, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light band, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transflective type polarizing plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, an adhesive layer may also be prepared for adhesion with other members, such as a liquid crystal cell etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

Moreover, an adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Proper method may be carried out to attach an adhesive layer to one side or both sides of the optical film. As an example, about 10 to 40 weight % of the pressure sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which an adhesive layer is once formed on a separator, as mentioned above, and is then transferred on a polarizing plate or an optical film may be mentioned.

An adhesive layer may also be prepared on one side or both sides of a polarizing plate or an optical film as a layer in which pressure sensitive adhesives with different composition or different kind etc. are laminated together. Moreover, when adhesive layers are prepared on both sides, adhesive layers that have different compositions, different kinds or thickness, etc. may also be used on front side and backside of a polarizing plate or an optical film. Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned each layer, such as a polarizer for a polarizing plate, a transparent protective film and an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

An optical film of the present invention may be preferably used for manufacturing various equipment, such as liquid crystal display, etc. Assembling of a liquid crystal display may be carried out according to conventional methods. That is, a liquid crystal display is generally manufactured by suitably assembling several parts such as a liquid crystal cell, optical films and, if necessity, lighting system, and by incorporating driving circuit. In the present invention, except that an optical film by the present invention is used, there is especially no limitation to use any conventional methods. Also any liquid crystal cell of arbitrary type, such as TN type, and STN type, π type may be used.

Suitable liquid crystal displays, such as liquid crystal display with which the above-mentioned optical film has been located at one side or both sides of the liquid crystal cell, and with which a backlight or a reflector is used for a lighting system may be manufactured. In this case, the optical film by the present invention may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic emitting layer and a metal electrode are laminated on a transparent substrate in an order configuring an illuminant (organic electro luminescence illuminant). Here, an organic emitting layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic emitting layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic emitting layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic emitting layer is formed by a very thin film about 10 nm in thickness. For this reason, light is transmitted nearly completely through organic emitting layer as through transparent electrode. Consequently, since the light that enters, when light is not emitted, as incident light from a surface of a transparent substrate and is transmitted through a transparent electrode and an organic emitting layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic emitting layer that emits light by impression of voltage, and at the same time equipped with a metal electrode on a back side of organic emitting layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

This means that only linearly polarized light component of the external light that enters as incident light into this organic EL display is transmitted with the work of polarizing plate. This linearly polarized light generally gives an elliptically polarized light by the retardation plate, and especially the retardation plate is a quarter wavelength plate, and moreover when the angle between the two polarization directions of the polarizing plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate, it cannot be transmitted through the polarizing plate. As the result, mirror surface of the metal electrode may be completely covered.

### EXAMPLES

Hereinafter, more detailed description of the present invention will be given with reference to Examples of this invention. In addition, a term “part” represents “part by weight” in following description.

### Example 1

A polyvinyl alcohol aqueous solution of 13% by weight of a solid content in which polyvinyl alcohol (manufactured by KURARAY CO., LTD., 98.5% of degrees of saponification, degree of polymerization 2400) and a liquid crystalline monomer (isotropic phase transition temperature of 46° C., UCL-001 manufactured by Dainippon Ink and Chemicals, Inc.) including Irgacure 369 (manufactured by Ciba Specialty Chemicals) 1% by weight to UCL-001 as a photopolymerization initiator were mixed, so as to be (polyvinyl alcohol): (liquid crystalline monomer)=100:3 (weight ratio). The obtained solution was agitated for 10 minutes at 6000 rpm in a homomixer, and a solution was obtained. The obtained solution was warmed in a 60° C. thermostat, an aqueous solution (22° C.) including iodine and potassium iodide was added dropwise into the solution while this temperature was maintained, and agitated to obtain a mixed solution. At this time, a ratio was adjusted so that (polyvinyl alcohol):(iodine):(potassium iodide)=100:1.54:10.8 (weight ratio) might be obtained. Gelation of this mixed solution was not observed. This mixed solution was cast, and after coated with an applicator it was slowly cooled. The obtained coated film was kept standing at room temperature for 6 hours, and then was dried for 30 minutes at 60° C. Thus a film was obtained in which minute domains of the liquid crystalline monomer and iodine were mixed in polyvinyl alcohol. Subsequently, the obtained mixed film was kept in an aqueous solution bath of boric acid of 3% by weight for 30 seconds at 30° C., and subsequently, it was stretched 5 times in this bath. Furthermore, after being immersed for 10 seconds in a 30° C. aqueous solution bath of potassium iodides of 5% by weight, it was dried for 4 minutes at 50° C. Then, ultraviolet radiation of 100 mJ/cm² was irradiated to the film using a metal halide lamp, and alignment of the liquid crystalline monomer was fixed to obtain a polarizer.

The obtained polarizer was observed using a polarizing microscope, and thereby it was identified that an infinite number of dispersed minute domains of the liquid crystalline monomer were formed in a polyvinyl alcohol matrix. This liquid crystalline monomer was observed to be aligned in a stretched direction, and an average size in the stretched direction (Δn² direction) of the minute domains gave 1 to 3 μm.

Refractive indexes of the matrix and the minute domains were measured separately. Firstly, an independent refractive index of a polyvinyl alcohol film stretched under the same stretching condition was measured with an Abbe refractometer (measurement light: 589 nm), and a refractive index=1.54 in the stretched direction (Δn¹ direction), a refractive index in the Δn² direction=1.52 were given. Moreover, the liquid crystalline monomer (UCL-001) was measured for refractive indexes (nₑ: extraordinary rays refractive index and nₒ: ordinary rays refractive index). The liquid crystalline monomer aligned and coated on a high refractive index glass to which perpendicular alignment processing was given was measured for nₒ using an Abbe refractometer (measurement light: 589 nm). On the other hand, a liquid crystalline monomer was introduced into a liquid crystal cell to which horizontal alignment processing was given, a retardation (Δn×d) was measured using an automatic birefringence measuring apparatus (manufactured by Oji Scientific Instruments, automatic birefringence meter KOBRA 21 ADH), a cell gap (d) was separately measured using an optical interference method, and then Δn was calculated from the (retardation)/(cell gap). This sum of An and nₒ was defined as nₑ. Values of nₑ (equivalent to a refractive index in a Δn¹ direction)=1.662 and nₒ (equivalent to a refractive index in a Δn² direction)=1.51, were obtained. Therefore, calculated results of Δn¹=0.12, Δn²=0.01 were obtained. In addition, the refractive index difference is shown by absolute value. From the above-mentioned results, it was confirmed that desired anisotropic scattering appeared.

In addition, although addition of a photopolymerization initiator and curing by ultraviolet radiation slightly vary refractive indexes of a liquid crystalline monomer, variation thereof is small. And when it is cured, function of the above-mentioned anisotropic scattering was satisfactorily developed without any problems.

### Comparative Example 1

Except for having not mixed a liquid crystalline monomer in preparation of the mixed solution in Example 1, a same operation as in Example 1 was repeated, and a polarizer was produced.

### Example 2

Polyvinyl alcohol (manufactured by KURARAY CO., LTD., degrees of saponification 98.5%, degree of polymerization 2400), potassium iodide, glycerin were mixed at a ratio of 100 parts, 30 parts, and 15 parts, respectively and an aqueous solution including 10% by weight of polyvinyl alcohol was prepared. A liquid crystalline monomer having each one acryloyl group at both of terminals of a mesogen group (nematic liquid crystal temperature range is 40 to 70° C.) was mixed in the obtained aqueous solution so that the liquid crystalline monomer might be 3 parts by weight to the polyvinyl alcohol 100 parts by weight. The obtained mixture was heated not less than the liquid crystal temperature range, agitated for 10 minutes at 6000 rpm by a homomixer, and a mixed solution was obtained. After degassing of air bubbles existing in the mixed solution concerned by kept standing at room temperature (23° C.), the mixed solution was coated using a cast method. Subsequently, it was dried at 120° C. and an opaque whitish mixed film with a thickness of 70 μm was obtained.

The obtained mixed film was immersed in a 10% by weight hydrogen peroxide solution for 30 seconds, subsequently was immersed in a 3% by weight of boric acid aqueous solution bath at 30° C., and the film was cross-linked. Subsequently, while the film being immersed in a 4% by weight aqueous solution bath of boric acids at 60° C., it was stretched 5 times. Subsequently, it was immersed in a 5% by weight aqueous solution of potassium iodide at 30° C., and hue regulation was performed. After the above wet stretching process, it was dried for 4 minutes at 50° C., and a polarizer was obtained.

The obtained polarizer was observed using a polarizing microscope, and thereby it was identified that an infinite number of dispersed minute domains of the liquid crystalline monomer were formed in a polyvinyl alcohol matrix. This liquid crystalline monomer was observed to be aligned in a stretched direction, and an average size in the stretched direction (Δn² direction) of the minute domains gave 1 to 3 μm.

Refractive indexes of the matrix and the minute domains were measured separately. Firstly, an independent refractive index of a polyvinyl alcohol film stretched under the same stretching condition was measured with an Abbe refractometer (measurement light: 589 nm), and a refractive index=1.54 in the stretched direction (Δn¹ direction), a refractive index in the Δn² direction=1.52 were given. Moreover, the liquid crystalline monomer was measured for a refractive indexes (nₑ: extraordinary rays refractive index and nₒ: ordinary rays refractive index) using a same method as in Example 1, and nₑ (equivalent to a refractive index in the Δn¹ direction)=1.66, and nₒ (equivalent to a refractive index of Δn² direction)=1.53 were given. Therefore, calculated results of Δn¹=0.12, Δn²=0.01 were obtained. From the above-mentioned results, it was confirmed that desired anisotropic scattering appeared.

### Comparative Example 2

Except for having not mixed the liquid crystalline monomer in Example 2, a same operation as in Example 2 was repeated, and a polarizer was produced.

(Evaluation)

Polarizers (sample) obtained in Examples 1 to 2 and Comparative examples 1 to 2 were measured for optical properties using a spectrophotometer with integrating sphere (manufactured by Hitachi Ltd. U-4100). Transmittance to each linearly polarized light was measured under conditions in which a completely polarized light obtained through Glan Thompson prism polarizer was set as 100%. Transmittance was calculated based on CIE 1931 standard calorimetric system, and is shown with Y value, for which relative spectral responsivity correction was carried out. Notation k₁ represents a transmittance of a linearly polarized light in a maximum transmittance direction, and k₂ represents a transmittance of a linearly polarized light perpendicular to the direction.

A polarization degree P was calculated with an equation P={(k₁−k₂)/(k₁+k₂)}×100. A transmittance T of a simple 15 substance was calculated with an equation T=(k₁+k₂)/2.

TABLE 1

| | Transmittance of linearly | | | |
|---|---|---|---|---|
| | polarized light (%) | | | |
| | Maximum | Perpen- | | |
| | transmittance | dicular | Transmittance | |
| | direction | direction | of simple | Polarization |
| | (k₁) | (k₂) | substance (%) | degree (%) |
| Example 1 | 83.49 | 0.673 | 42.08 | 98.40 |
| Comparative | 83.29 | 0.734 | 42.01 | 98.25 |
| Example 1 | | | | |
| Example 2 | 85.85 | 0.250 | 43.05 | 99.42 |
| Comparative | 85.74 | 0.301 | 43.02 | 99.30 |
| Example 2 | | | | |

Results of table 1 show that the polarizer in Example 1 has more improved light polarizing performance than the polarizer in Comparative Example 1. Both are stretched under same conditions and it is understood that a degree of alignment of the polyvinyl alcohol is almost equivalent. Therefore, it is understood that improvement in light polarizing performance originates in the above-described effect. Moreover, results of table 1 show similarly that the polarizer in Example 2 has a more improved light polarizing performance than the polarizer in Comparative Example 2.

What is claimes is:

1. A method for manufacturing a polarizer comprising a film having a structure wherein a minute domain is dispersed in a matrix formed of a translucent water-soluble resin including an iodine light absorbing material, the method comprising the steps of:
forming a film from a solution including the translucent water-soluble resin, iodine and a material forming the minute domain; and
stretching the film.

2. The method for manufacturing the polarizer according to claim 1, wherein the minute domain is formed of an aligned birefringent material.

3. The method for manufacturing the polarizer according to claim 2, wherein the birefringent material shows liquid crystalline at least in alignment processing step.

4. The method for manufacturing the polarizer according to claim 2, wherein the minute domain has 0.02 or more of birefringence.

5. The method for manufacturing the polarizer according to claim 2, wherein in a refractive index difference between the birefringent material forming the minute domain and the translucent water-soluble resin in each optical axis direction,
a refractive index difference (Δn¹) in direction of axis showing a maximum is 0.03 or more, and
a refractive index difference (Δn²) between the Δn¹ direction and a direction of axes of two directions perpendicular to the Δn¹ direction is 50% or less of the Δn¹.

6. The method for manufacturing the polarizer according to claim 1, wherein an absorption axis of the iodine light absorbing material is aligned in the Δn¹ direction.

7. The method for manufacturing the polarizer according to claim 1, wherein the minute domain has a length of 0.05 through 500 μm in the Δn² direction.

8. The method for manufacturing the polarizer according to claim 1, wherein the iodine light absorbing material has an absorbing band at least in a band of 400 through 700 nm wavelength range.

9. A polarizer obtained by the method for manufacturing the polarizer according to claim 1.

10. A polarizing plate having a transparent protective layer formed at least on one side of the polarizer according to claim 9.

11. An optical film having at least one of the polarizer according to claim 9.

12. An image display comprises the polarizer according to claim 9.

13. A method for manufacturing a polarizer comprising a film having a structure wherein a minute domain is dispersed in a matrix formed of a translucent water-soluble resin including an iodine light absorbing material, the method comprising the steps of:
forming a film from a solution including the translucent water-soluble resin, an alkali metal iodide and a material forming the minute domain;
oxidizing the iodide to form iodine; and
stretching the film.

14. The method for manufacturing the polarizer according to claim 13, wherein the minute domain is formed of an aligned birefringent material.

15. The method for manufacturing the polarizer according to claim 14, wherein the birefringent material shows liquid crystalline at least in alignment processing step.

16. The method for manufacturing the polarizer according to claim 14, wherein the minute domain has 0.02 or more of birefringence.

17. The method for manufacturing the polarizer according to claim 14, wherein in a refractive index difference between the birefringent material forming the minute domain and the translucent water-soluble resin in each optical axis direction,
a refractive index difference (Δn¹) in direction of axis showing a maximum is 0.03 or more, and
a refractive index difference (Δn²) between the Δn¹ direction and a direction of axes of two directions perpendicular to the Δn¹ direction is 50% or less of the Δn¹.

18. The method for manufacturing the polarizer according to claim 13, wherein an absorption axis of the iodine light absorbing material is aligned in the Δn¹ direction.

19. The method for manufacturing the polarizer according to claim 13, wherein the minute domain has a length of 0.05 through 500 μm in the Δn² direction.

20. The method for manufacturing the polarizer according to claim 13, wherein the iodine light absorbing material has an absorbing band at least in a band of 400 through 700 nm wavelength range.

21. A polarizer obtained by the method for manufacturing the polarizer according to claim 13.

22. A polarizing plate having a transparent protective layer formed at least on one side of the polarizer according to claim 21.

23. An optical film having at least one of the polarizer according to claim 21.

24. An image display comprises the polarizer according to claim 21.
